(19) United States
(12) Patent Application Publication
(10) Pub. No.: US 2002/0168091 A1
(43) Pub. Date: Nov. 14, 2002

(54) Motion detection via image alignment

(76) Inventor: Miroslav Trajkovic, Ossining, NY (US)

Correspondence Address: Corporate Patent Counsel, U.S. Philips Corporation, 580 White Plains Road, Tarrytown, NY, 10591, US

(21) Appl. No.: 09/854,043

(22) Filed: May 11, 2001

(51) Int. Cl. G06K 9/00; G06K 9/62; G06K 9/32

(52) U.S. Cl. 382/107; 382/294; 382/224

(57) ABSTRACT

Pixels of an image are classified as being stationary or moving, based on the gradient of the image in the vicinity of each pixel. The values of corresponding pixels in two sequential images are compared. If the difference between the values is less than the image gradient about the pixel location, or less than a given threshold value above the image gradient, the pixel is classified as being stationary. By classifying each pixel based on the image gradient in the vicinity of the pixel, the sensitivity of the motion detection classification is reduced at the edges of objects, and other regions of contrast in an image, thereby minimizing the occurrences of ghost artifacts caused by the misclassification of stationary pixels as moving pixels.

### BACKGROUND OF THE INVENTION

1. Field of the Invention

This invention relates to the field of image processing, and in particular to the detection of motion between successive images.

2. Description of Related Art

Motion detection is commonly used to track particular objects within a series of image frames. For example, security systems can be configured to process images from one or more cameras, to autonomously detect potential intruders into secured areas, and to provide appropriate alarm notifications based on the intruder's path of movement. Similarly, videoconferencing systems can be configured to automatically track a selected speaker, or a home automation system can be configured to track occupants and to correspondingly control lights and appliances in dependence upon each occupant's location.

A variety of motion detection techniques are available for use with static cameras. An image from a static camera will provide a substantially constant background image, upon which moving objects form a dynamic foreground image. With a fixed field of view, motion-based tracking is a fairly straightforward process. The background image (identified by equal values in two successive images) is ignored, and the foreground image is processed to identify individual objects with the foreground image. Criteria such as object size, shape, color, etc. can be used to distinguish objects of potential interest, and pattern matching techniques can be applied to track the motion of the same object from frame to frame in the series of images from the camera.

Object tracking can be further enhanced by allowing the tracking system to control one or more cameras having an adjustable field-of-view, such as cameras having an adjustable pan, tilt, and/or zoom capability. For example, when an object that conforms to a particular set of criteria is detected within an image, the camera is adjusted to keep the object within the camera's field of view. In a multi-camera system, the tracking system can be configured to “hand-off” the tracking process from camera to camera, based on the path that the object takes. For example, if the object approaches a door to a room, a camera within the room can be adjusted so that its field of view includes the door, to detect the object as it enters the room, and to subsequently continue to track the object.

As the camera's field of view is adjusted, the background image “appears” to move, making it difficult to distinguish the actual movement of foreground objects from the apparent movement of background objects. If the camera control is coupled to the tracking system, the images can be pre-processed to compensate for the apparent movements that are caused by the changing field of view, thereby allowing for the identification of foreground image motion.

If the tracking system is unaware of the camera's changing field of view, image processing techniques can be applied to detect the motion of each object within the sequence of images, and to associate the common movement of objects to an apparent movement of the background objects caused by a change of the camera's field of view. Movements that differ from this common movement are then associated to objects that form the foreground images.

Regardless of the technique used to estimate or calculate the effects that a change of camera's field of view will have on the image, motion detection is typically accomplished by aligning sequential images, and then detecting changes between the aligned images. Because of inaccuracies in the alignment process, or inconsistencies between sequential images, artifacts are produced as stationary background objects are mistakenly interpreted to be moving foreground objects. Generally, these artifacts appear as “ghost images” about objects, as the edges of the objects are reported to be moving, because of the misalignment or inconsistencies between the two aligned images. These ghosts can be reduced by ignoring differences between the images below a given threshold. If the threshold is high, the ghost images can be substantially eliminated, but a high threshold could cause true movement of objects to be missed, particularly if the object is moved slowly, or if the moving object is similar to the background.

### BRIEF SUMMARY OF THE INVENTION

It is an object of this invention to provide a system and method that accurately distinguishes between moving and stationary objects in successive images. It is a further object of this invention to provide a system and method that minimizes the classification of stationary objects as moving objects. It is a further object of this invention to prevent the generation of ghost images about stationary objects in a motion detection scheme.

These objects and others are achieved by classifying pixels of an image, as stationary or moving, based on the gradient of the image in the vicinity of each pixel. The values of corresponding pixels in two sequential images are compared. If the difference between the values is less than the image gradient about the pixel location, or less than a given threshold value above the image gradient, the pixel is classified as being stationary. By classifying each pixel based on the image gradient in the vicinity of the pixel, the sensitivity of the motion detection classification is reduced at the edges of objects, and other regions of contrast in an image, thereby minimizing the occurrences of ghost artifacts caused by the misclassification of stationary pixels as moving pixels.

### BRIEF DESCRIPTION OF THE DRAWINGS

The invention is explained in further detail, and by way of example, with reference to the accompanying drawings wherein:

FIG. 1 illustrates an example flow diagram of an image processing system in accordance with this invention.

FIG. 2 illustrates an example block diagram of an image processing system in accordance with this invention.

FIG. 3 illustrates an example flow diagram of a process for distinguishing background pixels and foreground pixels in accordance with this invention.

Throughout the drawings, the same reference numerals indicate similar or corresponding features or functions.

### DETAILED DESCRIPTION OF THE INVENTION

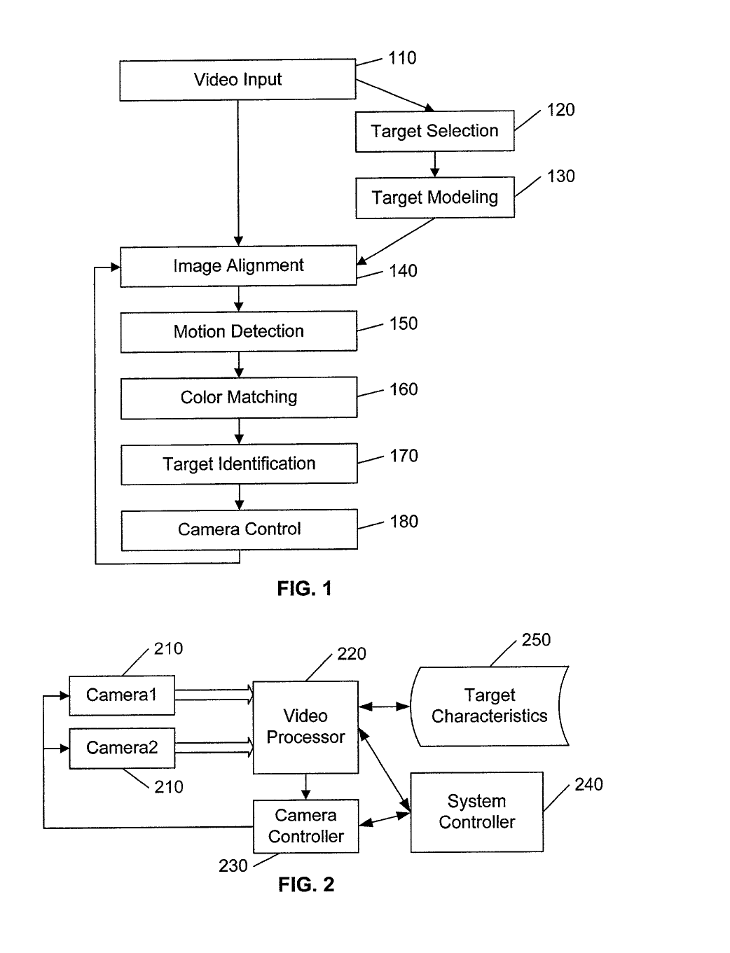

FIG. 1 illustrates an example flow diagram of an image tracking system in accordance with this invention. Video input, in the form of image frames is continually received, at 110, and continually processed, via the image processing loop 140-180. At some point, either automatically or based on manual input, a target is selected for tracking within the image frames, at 120. After the target is identified, it is modeled for efficient processing, at 130. At block 140, the current image is aligned to a prior image, taking into account any camera adjustments that may have been made, at block 180. After aligning the prior and past images in the image frames, the motion of objects within the frame is determined, at 150. Generally, a target that is being tracked is a moving target, and the identification of independently moving objects improves the efficiency of locating the target, by ignoring background detail. At 160, color matching is used to identify the portion of the image, or the portion of the moving objects in the image, corresponding to the target. Based on the color matching and/or other criteria, such as size, shape, speed of movement, etc., the target is identified in the image, at 170. In an integrated security system, the tracking of a target generally includes controlling one or more cameras to facilitate the tracking, at 180.

As would be evident to one of ordinary skill in the art, a particular tracking system may contain fewer or more functional blocks than those illustrated in the example system of FIG. 1. For example, a system that is configured to merely detect motion, without regard to a specific target, need not include the target selection and modeling blocks 120, 130, nor the color matching and target identification blocks 160, 170. Alternatively, to minimize false-alarms, such a system may be configured to provide a “general” description of a potential targets, such as a minimum size or a particular shape, in the target modeling block 130, and detect such a target in the target identification block 170. In like manner, a system may be configured to ignore particular targets, or target types, based on general or specific modeling parameters.

Not illustrated, the target tracking system may be configured to effect other operations as well. For example, in a security application, the tracking system may be configured to activate audible alarms if the target enters a secured zone, or to send an alert to a remote security force, and so on. In a home-automation application, the tracking system may be configured to turn appliances and lights on or off in dependence upon an occupant's path of motion, and so on.

The tracking system is preferably embodied as a combination of hardware devices and programmed processors. FIG. 2 illustrates an example block diagram of an image tracking system 200 in accordance with this invention. One or more cameras 210 provide input to a video processor 220. The video processor 220 processes the images from one or more cameras 210, and, if configured for target identification, stores target characteristics in a memory 250, under the control of a system controller 240. In a preferred embodiment, the system controller 240 also facilitates control of the fields of view of the cameras 210, and select functions of the video processor 220. As noted above, the tracking system 200 may control the cameras 210 automatically, based on tracking information that is provided by the video processor 220.

This invention primarily relates to the motion detection 150 task of FIG. 1. Conventionally, the values of corresponding pixels in two sequential images are compared to detect motion. If the difference between the two pixel values is above a threshold amount, the pixel is classified as a ‘foreground pixel’, that is, a pixel that contains foreground information that differs from the stationary background information. As noted above, if the camera's field of view is changeable, the sequential images are first aligned, to compensate for any apparent motion caused by a changed field of view. If the camera's field of view is stationary, the images are assumed to be aligned. Copending U.S. patent application “MOTION-BASED TRACKING WITH PAN-TILT-ZOOM CAMERA”, serial number______ , filed______ for Miroslav Trajkovic, Attorney Docket US010240, presents a two-stage image alignment process that is well suited for both small and large changes in a camera's field of view, and is incorporated by reference herein. In this copending application, low-resolution representations of the two sequential images are used to determine a coarse alignment between the images. Based on this coarse alignment, high-resolution representations of the two coarsely aligned sequential images are used to determine a more precise alignment between the images. By using a two-stage approach, better alignment is achieved, because biases that may be introduced by foreground objects that are moving relative to the stationary background are substantially eliminated from the second stage alignment.

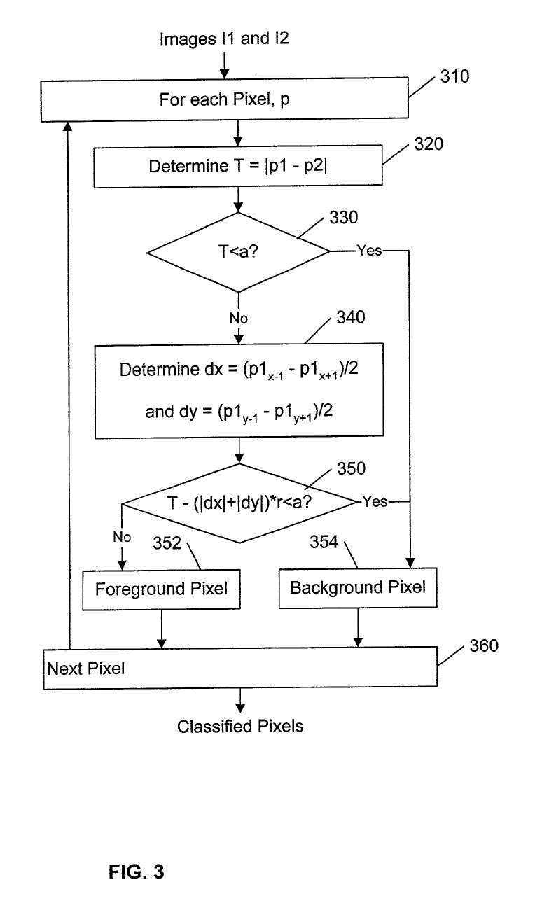

FIG. 3 illustrates an example flow diagram for a pixel classification process in accordance with this invention. The loop 310-360 is structured in this example to process each pixel in a pair of aligned images I1 and I2. In particular applications, select pixels may be identified for processing, and the loop 310-360 would be adjusted accordingly. For example, in a predictive motion detecting system, the processing may be limited to a region about an expected location of a target; in a security area with limited access points, the processing may be initially limited to regions about doors and windows; and so on. At 320 the magnitude of the difference, T, between the value of the pixel in the first image, p1, and the value of the pixel in the second image, p2, is determined. This difference T is compared to a threshold value, a, at 330. If the difference T is less than the threshold a, the pixel is classified as a background pixel, at 354. Blocks 320-330 are consistent with the conventional technique for classifying a pixel as background or foreground. In a conventional system, however, if the difference T is greater than the threshold a, the pixel is classified as a foreground pixel. The determination of the difference T depends upon the components of the pixel value. For example, if the pixel value is an intensity value, a scalar subtraction provides the difference. If the pixel value is a color, a color-distance provides the difference. Techniques for determining differences between values associated with pixels are common in the art.

In accordance with this invention, if the difference T is greater than the threshold a, the difference T is subjected to another test 350 before classifying the pixel as either foreground 352 or background 354. The additional test 350 compares the difference T to the image gradient about the pixel, p. That is, for example, if the pixel value corresponds to a brightness, or grayscale level, the additional test 350 compares the change in brightness level of the pixel in each of the two images to the change of brightness contained in the region of the pixel. If the change in brightness between the two images is similar to or less than the change of brightness in the region of the pixel, it is likely that the change in brightness between the two images is caused by a misalignment between the two images. If the region about a pixel has a relatively constant value, and a next-image shows a difference in the pixel value above a threshold level, it is likely that something has moved into the region. If the region about a pixel has a high brightness gradient, changes in pixel values in a new image may corresponding to something moving into the region, or, it may likely correspond to misalignments of the image, wherein a prior adjacent pixel value shifts its location slightly between images. To prevent false classification of a background pixel as a foreground pixel, a pixel is not classified as a foreground pixel unless the difference in value between images is substantially greater than the changes that may be due to image misalignment.

In the example flow diagram of FIG. 3, a two-point differential is used to identify the image gradient in each of the x and y axes, at 340. Alternative schemes are available for creating gradient maps, or otherwise identifying spatial changes in an image. The image gradient in the example block 340 for a pixel at location (x,y) is determined by:

dx=(p1(x−1, y)−p1(x+1, y))/ 2

dy=(p1(x,y−1)−p1(x,y+1))/2

These dx and dy terms above correspond to an average change in the pixel value in each of the horizontal and vertical axes. Alternative measures of an image gradient are common in the art. For example, the second image values p2(ij) could be used in the above equations; or, the gradient could be determined based on an average of the gradients in each of the images; or, more than two points may be used to estimate the gradient; and so on. Multivariate gradient measures may also be used, corresponding to the image gradient along directions other than horizontal and vertical.

The example test 350 subtracts the sum of the magnitude of the average change in pixel value in each of the horizontal and vertical axes, multiplied by a ‘misalignment factor’, r, from the change T in pixel value between the two images, to provide a measure of the change between sequential images relative to the change within the image (T−(|dx|+|dy|)*r). The misalignment factor, r, is an estimate of the degree of misalignment that may occur, depending upon the particular alignment system used, the environmental conditions, and so on. If very little misalignment is expected, the value of r is set to a value less than one, thereby providing sensitivity to slight differences, T, between sequential images. If a large misalignment is likely, the value of r is set to a value greater than one, thereby reducing the likelihood of false motion detection due to misalignment. In a preferred embodiment, the misalignment factor has a default value of one, and is user-adjustable as the particular situation demands.

The change in pixel values between sequential images relative to the image gradient (T−(|dx|+|dy|)*r) is compared to the threshold level, a. If the relative change is less than the threshold, the pixel is classified as a background pixel, at 354; otherwise, it is classified as a foreground pixel, at 352. That is, in accordance with this invention, if the change in value of corresponding pixels in two aligned sequential images is greater than a measure of the change in pixel value within the images by a threshold amount, the pixel is classified as a foreground pixel that is distinguishable from pixels that contain stationary background image elements. Note that the threshold level in the test 350 need not be the same threshold level that is used in test 330, and is not constrained to a positive value. As would be evident to one of ordinary skill in the art, the misalignment factor and the threshold level may be combined in a variety of forms to effect other criteria for distinguishing between background and foreground pixels. Note also that, in view of the test 350, the test 330 is apparently unnecessary. The test 330 is included in a preferred embodiment in order to avoid having to compute the image gradient 340 for pixels having little or no change between images.

As with the determination of the measure of image gradient, there are alternative tests 350 that may be applied. For example, the change T may be compared to a maximum of the gradient in each axis, rather than a sum, and so on. Similarly, the criteria may be a relative, or normalized, comparison, such as a comparison of T to a factor of the gradient measure (such as “twenty percent more than the maximum gradient in each axis”). These and other techniques for comparing a difference in pixel values between images to a difference in pixel values within an image will be evident to one of ordinary skill in the art.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A method for identifying motion in a sequence of images comprising:
determining a difference in pixel value between a pixel in a first image and a corresponding pixel in a second image,
determining an image gradient measure in a vicinity of the pixel, and
classifying the pixel as stationary based on the difference in pixel value and the image gradient measure.

2. The method of claim 1, further including:
classifying the pixel as stationary based on a comparison of the difference in pixel value to a defined threshold level.

3. The method of claim 1, wherein
determining the image gradient includes:
determining a first average change in pixel values between pixels to the left and right of the pixel, and
determining a second average change in pixel values between pixels above and below the pixel.

4. The method of claim 1, further including
aligning the first image and the second image.

5. The method of claim 1, further including
classifying the pixel as non-stationary if a difference between the difference in pixel value and the image gradient measure is greater than a defined threshold level.

6. The method of claim 1, wherein
classifying the pixel is further based on a misalignment factor that corresponds to an estimate of a misalignment between the first and second images.

7. A motion detecting system comprising:
a processor that is configured to:
determine a difference in pixel value between a pixel in a first image and a corresponding pixel in a second image,
determine an image gradient measure in a vicinity of the pixel, and
classify the pixel as containing stationary or moving data, based on the difference in pixel value and the image gradient measure.

8. The motion detecting system of claim 7, wherein
the processor is further configured to classify the pixel as containing stationary or moving data, based on a comparison of the difference in pixel value to at least one of:
a defined threshold level, and
a threshold level that is dependent upon a misalignment factor that corresponds to a degree of misalignment between the first and second images.

9. The motion detecting system of claim 7, wherein
the processor is configured to determine the image gradient by:
determining a first average change in pixel values between pixels to the left and right of the pixel, and
determining a second average change in pixel values between pixels above and below the pixel.

10. The motion detecting system of claim 7, wherein
the processor is further configured to align the first image and second images.

11. The motion detecting system of claim 7, wherein
the processor classifies the pixel as containing moving data if a difference between the difference in pixel value and the image gradient measure is greater than a defined threshold level.

12. The motion detecting system of claim 7, further including
one or more cameras that are configured to provide the first and second images.

13. A computer program, which, when executed by a processor, causes the processor to:
determine a difference in pixel value between a pixel in a first image and a corresponding pixel in a second image,
determine an image gradient measure in a vicinity of the pixel, and
classify the pixel as containing stationary or moving data, based on the difference in pixel value and the image gradient measure.

14. The computer program of claim 13, which further causes the processor to:
classify the pixel as containing stationary or moving data, based on a comparison of the difference in pixel value to at least one of:
a defined threshold level, and
a threshold level that is dependent upon a misalignment factor that corresponds to a degree of misalignment between the first and second images.

15. The computer program of claim 13, wherein the image gradient is determined by:
determining a first average change in pixel values between pixels to the left and right of the pixel, and
determining a second average change in pixel values between pixels above and below the pixel.

16. The computer program of claim 13, which further causes the processor to align the first image and second images.

17. The computer program of claim 13, which further causes the processor to classify the pixel as containing moving data if a difference between the difference in pixel value and the image gradient measure is greater than a defined threshold level.
